(19) United States
(12) Patent Application Publication
(10) Pub. No.: US 2008/0080702 A1
(43) Pub. Date: Apr. 3, 2008

(54) Method, System, and Computer-Readable Medium for Calculating an Echo Path Delay

(75) Inventors: Naigang ZHANG, Plano, TX (US); Allen Y. TONG, Plano, TX (US); Sam O. PERRY, Garland, TX (US); Kuang-I SHU, Plano, TX (US)

Correspondence Address: HAYNES AND BOONE, LLP, 901 Main Street, Suite 3100, Dallas, TX, 75202, US

(73) Assignee: SANTERA SYSTEMS, INC., Plano, TX (US)

(21) Appl. No.: 11/538,384

(22) Filed: Oct. 3, 2006

(51) Int. Cl. H04M 9/08

(52) U.S. Cl. 379/406.08

(57) ABSTRACT

A method, system, and computer-readable medium for calculating a minimum echo path delay are provided. An accurate calculation of a minimum echo path delay is made based on characteristics of the echo path. The minimum echo path delay calculation may be periodically repeated thus providing for dynamic calculation of the minimum echo path delay in a manner that accounts for variations in echo path characteristics. The minimum echo path delay may be calculated based on discrete processing latencies identified in the echo path, by a network round trip delay, or by modeling an acoustic echo of an in-band audio signal, performing a frequency analysis thereon to calculate a spectrum signature of the modeled acoustic echo, and monitoring a send path for a match with the modeled acoustic echo after applying an instance of the in-band audio signal into the echo path.

### BACKGROUND

In the context of telephony, line echo is an impairment that occurs when energy of the speaker's voice signal is reflected off an impedance mismatch in the network. A common source of line echo is caused by an impedance mismatch between the balancing network of a hybrid, or isolation transformer, that couples two-wire local customer loops to four-wire long-distance trunks. A hybrid transformer is designed to pass the far-end signal at the four-wire receive port to a two-wire transmit port without allowing leakage into the four-wire transmit port. However, the exact impedance seen at the two-wire ports may vary widely and thus can only be estimated. As a result, a leakage signal often is returned to the far-end talker as an echo. Echo degrades transmission quality of a connection and, depending on the severity, may distract or annoy the call participants, and in severe cases may render the phone conversation unintelligible. The degree of degradation caused by echo may generally be characterized by two factors: the reflected voice energy and the length of the echo delay.

A network-based echo canceller, such as a hybrid echo canceller, may remove echo without affecting the near-end talker signal. The echo canceller cancels the reflection from the near-end return signal. An estimated echo is generated by an adaptive filter which adapts to model the tail circuit (near-end echo path) response thus producing a replica of the echo returning from the near-end. The output of the adaptive filter is a replica of the echo signal and it is subtracted from the hybrid device output. The echoes may be substantially eliminated under many circumstances from this signal and it is then used again to adjust the filter weights. Remaining residual echo may be further attenuated by a nonlinear processor.

Acoustic echo comprises a reflected signal resulting from an acoustic coupling between the earphone/loudspeaker and microphone of a telecommunication device, such as a hands-free mobile station. Encoded acoustic echo comprises the acoustic echo signal that has passed through the codecs and any other signal processing in the telecommunication network.

Contemporary communication devices may feature acoustic echo suppression functions that attenuate acoustic echo at the communication device, e.g., by subtracting an output signal, or a derivative thereof, detected at the earphone or loudspeaker, from the input signal supplied to the microphone. However, the performance of such acoustic echo suppression functions may vary greatly from device-to-device. Moreover, the acoustic echo path is often dynamic in nature because acoustic characteristics of the ambient environment may change due to, for example, the communication device being carried into different rooms or locations. Thus, regardless of the quality of an acoustic echo suppression function, acoustic echo is often encountered in telephone calls.

Network-based acoustic echo suppression may be implemented in the transmission network to alleviate acoustic echo. An acoustic echo controller (AEC) comprises a signal processing echo suppression function located in the digital transmission path which has the objective of improving subjective speech quality by reducing or removing encoded acoustic echo. As noted above, acoustic echo is generated at a terminal device and is transmitted together with signals originating from the terminal device to the location of voice enhancement devices through the air interface, speech codecs, and other signal processing and transport functions of the mobile network.

An acoustic echo control function, or echo suppression, may have the following general characteristics: the ability to reduce acoustic echo generated in the mobile handsets, the ability to maintain quality of the signals originating from mobile handsets, the ability to not corrupt voice-band data or facsimile signals, the ability not to interfere with in-band network signaling tones, low throughput delay, and may provide 64 kbit/s bit-sequence integrity when disabled.

Echo suppressors often tend to produce speech clipping or distortion, especially during calls with long transmission delays, and may pass an acoustic echo when the echo path is particularly small. Echo suppressors are generally supplied with an echo path delay for the purpose of determining when to activate echo suppression. Contemporary echo suppressors are provided with a static or pre-defined echo path delay estimate. However, such echo path delay estimates do not account for dynamic characteristics in the echo path, such as changes in the terminal-to-terminal configuration, movement of a terminal device during a phone call, processing latencies inherent in the transmission network, or other network characteristics. Accordingly, echo path delay estimates implemented in conventional echo suppressors are often highly inaccurate and static in nature and may introduce errors in the echo suppression function that introduce voice clipping, distortion, or delays in suppression that result in echo pass through that is received by a far-end terminal device.

Accordingly, it is desirable to provide a dynamic echo path delay calculation mechanism for use in an AEC that accounts for transmission network characteristics, such as processing latencies inherent in the network and/or variations in the delay path between the network and terminal device.

### BRIEF DESCRIPTION OF THE DRAWINGS

Aspects of the present disclosure are best understood from the following detailed description when read with the accompanying figures, in which:

FIG. 1 is a diagrammatic representation of an embodiment of an exemplary converged network in which embodiments disclosed herein may be implemented;

FIG. 2 is a diagrammatic representation of a hybrid echo canceller that can remove or attenuate echo without affecting the near-end talker signal;

FIG. 3 is a diagrammatic representation of a telecommunication system featuring an acoustic echo controller;

FIG. 4 is a diagrammatic representation of an exemplary embodiment of an acoustic echo controller depicted in FIG. 3;

FIG. 5A is a diagrammatic representation of a portion of a network system in which a minimum echo path delay is calculated based on transmission characteristics of the echo path in accordance with embodiments disclosed herein;

FIG. 5B is a diagrammatic representation of a portion of a network system in which a minimum echo path delay is calculated based on an IP network round trip delay;

FIG. 6 is a flowchart of an embodiment of a minimum echo path delay calculation subroutine for calculating a minimum echo path delay based on discrete processing latencies in the echo path;

FIG. 7 is a flowchart of another embodiment of a minimum echo path delay calculation subroutine for calculating a minimum echo path delay based on an IP round trip delay;

FIG. 8 is a flowchart depicting another embodiment of a minimum echo path delay calculation subroutine for calculating a minimum echo path delay; and

FIG. 9 is a flowchart of an embodiment of a test signal spectrum signature calculation subroutine that facilitates calculation of a minimum echo path delay.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

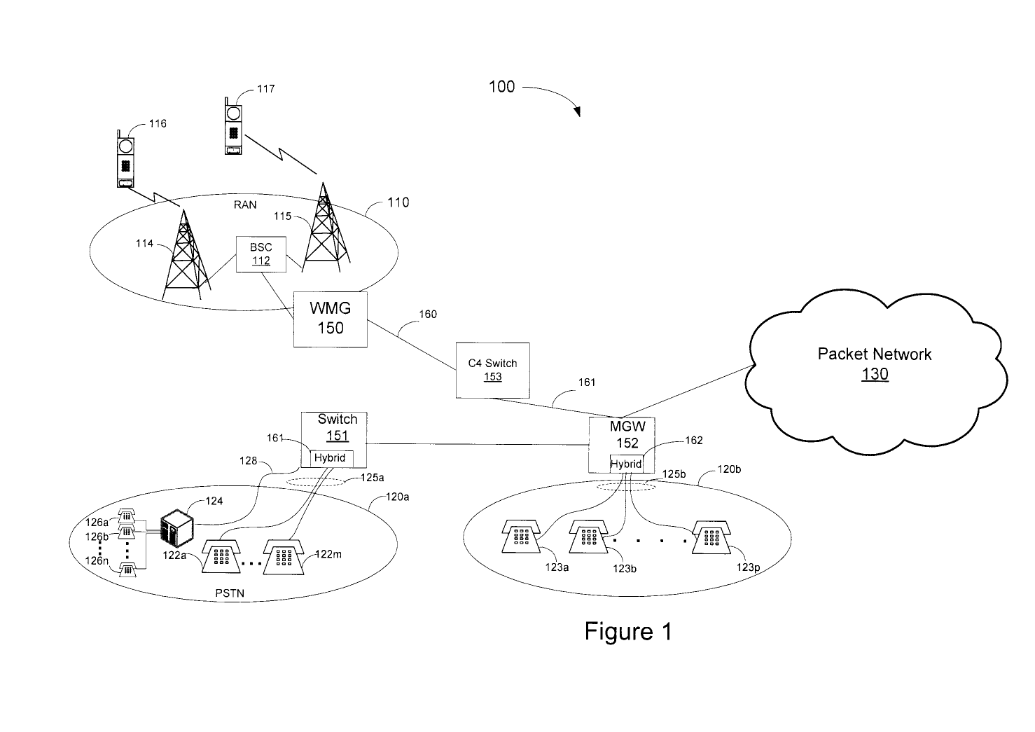

FIG. 1 is a diagrammatic representation of an embodiment of an exemplary converged network 100 comprising wireless, wireline, e.g., PSTN, and packet networks in which embodiments disclosed herein may be implemented. Network 100 may include several networks and/or portions of networks interconnected by various infrastructure. In the illustrative example, network 100 includes a radio access network 110, public switched telephone network (PSTN) access networks 120a-120b, and a packet network 130.

Radio access network (RAN) 110 may include a base station controller (BSC) 112 that is coupled with one or more base transceiver stations (BTSs) 114-115 that provide an over-the-air interface with one or more wireless mobile terminals 116-117. BTSs 114-115 include equipment for transmitting and receiving radio signals with mobile terminals 116-117. BTSs 116-117 may be adapted to encrypt and decrypt communications made with BSC 112 which may provide control to a plurality of BTSs. In the illustrative example, BSC 110 interfaces with a switching wireless media gateway (WMG) 150 that provides for communications between devices in RAN 110 with other access networks, such as PSTN access networks 120a-120b and packet network 130. RAN 110 and WMG 150 may comprise part of a cellular or mobile telecommunications network, such as a network compliant with the Global System for Mobile (GSM) Communications standards, Universal Mobile Telecommunications System (UMTS), or another mobile or cellular radio system.

PSTN access network 120a may include various devices, such as residential telephones 122a-122m, and/or one or more private branch exchanges (PBXs) 124. PBX 124 may connect with switch 151 via one or more trunk lines 128. Various devices 126a-126n, such as telephones, communication terminals, facsimile machines, and the like, may be connected with PBX 124. Residential telephones 122a-122m may be coupled by local loops 125a with switch 151, such as a class 5 switch, that may be deployed as a central office. In other implementations, telephones 122a-122m may be coupled with switch 151 by digital loop carriers, PBXs, digital concentrators, and/or other aggregators, or may otherwise be configured to communicate with switch 151 through PSTN access network 120a. Loops 125a may include digital loops and/or analog loops, and may be configured to transmit time-division multiplexed (TDM) and other PSTN data, among others. Loops 125a may comprise, for example, a respective twisted copper pair terminating telephones 122a-122m. A hybrid transformer 161 may couple two-wire local customer loops 125a to four-wire long-distance trunks.

In a similar manner, PSTN access network 120b may include a variety of communication devices 123a-123p that may be interconnected with a switching media gateway (MGW) 152 via local loops 125b or other suitable couplings. In this implementation, media gateway 152 may provide switching services and media handling across various platforms. Accordingly, MGW 152 may interface with one or more network types, such as PSTN access network 120b and packet network 130. In other implementations, MGW 152 may interface with a RAN and thus may include one or more wireless network interfaces. Moreover, MGW 152 may provide both Class 4 and Class 5 switching services and thus may aggregate traffic from other network entities, such as switch 151 interconnected therewith, and may provide switching services to termination points in networks 120b and 130. A hybrid transformer 162 may couple two-wire local customer loops 125b to four-wire long-distance trunks.

Packet network 130, such as the Internet or another packet switching network, may include interconnected computer networks, data processing systems, communication devices, packet switching infrastructure, and the like. Packet network 130 may interface with one or more switches, such as switching MGW 152. In the illustrative example, MGW 152 interfaces with PSTN access network 120b and packet network 130, and thus may include both TDM switching and packet switching capabilities.

Switch 153 may aggregate traffic from any number of telecommunication nodes, such as MGWs 150 and 152 connected therewith via respective trunks 160 and 161, other network switches, and the like, and thus may be implemented as a Class 4 switch. Accordingly, any device in RAN 110, PSTN access networks 120a and 120b, and packet network 130 may communicate with any other device in RAN 110, PSTN access networks 120a and 120b, and packet network 130. In accordance with embodiments disclosed herein, mechanisms for calculating a minimum echo path delay are provided for utilization by an AEC deployed in network 100.

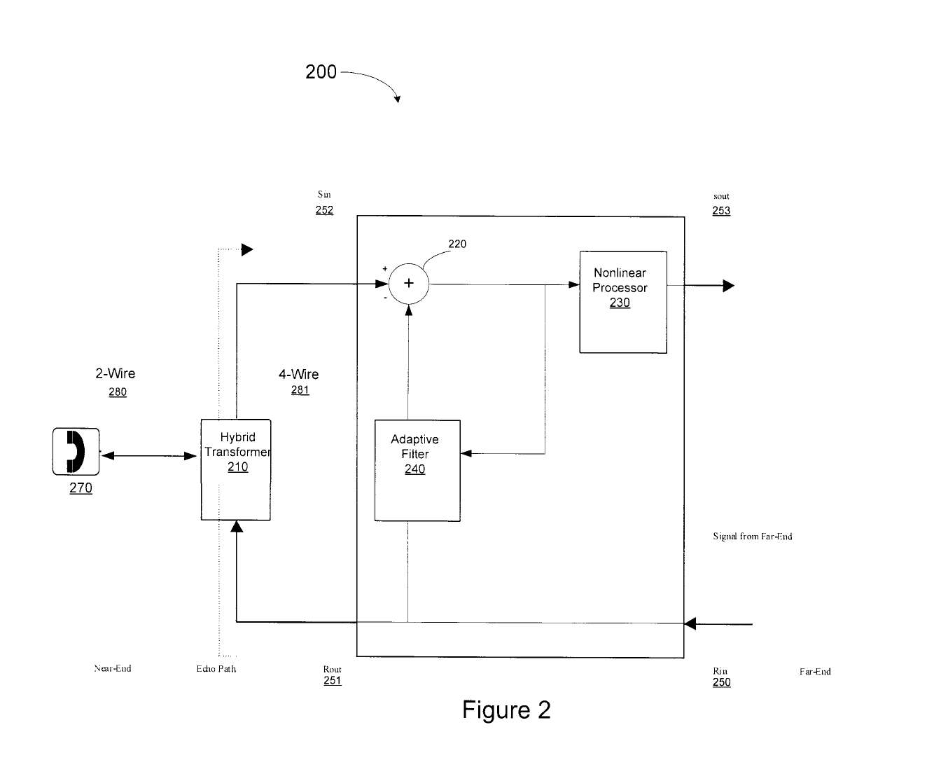

FIG. 2 is a diagrammatic representation of a hybrid echo canceller 200 that can remove or attenuate echo without affecting the near-end talker signal. A receive path input signal 250, Rin, is supplied to a 4-wire circuit 281 and is transmitted to a terminating device 270 in a 2-wire local loop 280. A far-end receive path signal 251, Rout, is received by a hybrid transformer 210. Ideally, hybrid transformer 210 passes the far-end receive path signal 251 at the four-wire receive port of hybrid transformer 210 through to the two-wire transmit port without allowing leakage into the four-wire transmit port of the send path. However, due to impedance mismatches, part of far-end receive path signal 251 may be reflected as a near-end echo signal that is input on the near-end send path. Thus, the near-end send path signal 252, Sin, may include an echo component that is transmitted on the send-path back into 4-wire circuit 281, and an echo component is included in far-end send path signal 253.

Echo canceller 200 may cancel the reflection from near-end send path signal 252 that is applied to a subtractor 220. An estimated echo is generated by an adaptive filter 240 which adapts to model the tail circuit (near-end echo path) response thus producing a replica of the echo returning from the near-end. The output of adaptive filter 240 is a replica of the echo signal and is subtracted from the hybrid device output, i.e., the near-end send path signal 252. The echoes may be substantially eliminated from this signal and it is then used again to adjust the filter weights, e.g., by supply of subtractor 220 output as an input to adaptive filter 240. Any remaining residual echo may be further attenuated by a nonlinear processor 230.

An acoustic echo controller suppresses echo generated from an acoustic coupling at a terminal device. The performance of such acoustic echo control is significantly impacted by the AEC's knowledge of the echo path delay. Mechanisms for accurately calculating a minimum echo path delay described herein provide for improved determination of an echo path delay, and thus enhanced call quality may be had by improved AEC performance.

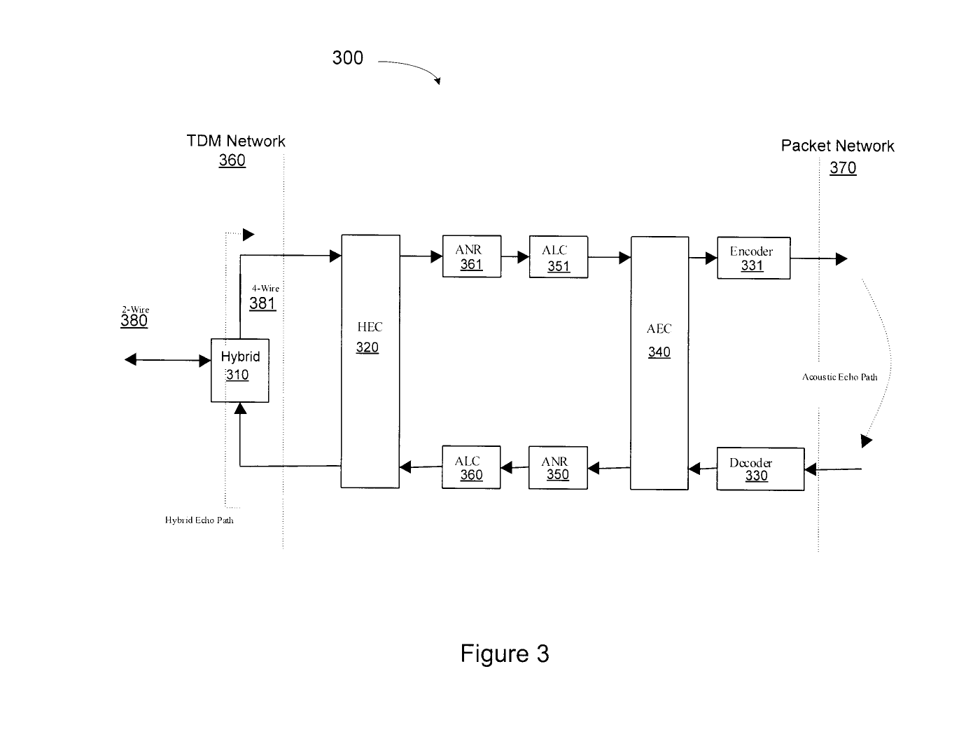

FIG. 3 is a diagrammatic representation of a telecommunication system 300 featuring an AEC 340. System 300 depicts an echo controller system that may be deployed on a media gateway that interfaces a time division multiplex (TDM) communication system 360 with a packet network 370, such as an Internet Protocol (IP) network. A hybrid transformer 310 interfaces a 2-wire local loop 380 with a 4-wire trunk 381. A hybrid echo canceller 320 may be deployed in system 300 that is configured similar to echo canceller 200 described above with reference to FIG. 2. On the send-path of packet network 370, a decoder 330 may be deployed for converting packet data supplied from packet network 370 to TDM data, pulse code modulated data, or another data format suitable for processing by AEC 340. Decoder 330 may be coupled to an input of AEC 340 that provides for acoustic echo suppression. AEC 340 may supply a send path signal to an active noise reduction (ANR) function 350 that, in turn, is coupled to an automatic level control (ALC) function 360 connected with an input of HEC 320 in the transmission path from packet network 370 to TDM network 360. In a similar manner, HEC 320 may be connected with an ANR 361 in the send path of TDM network 360 that is, in turn, coupled with an ALC 351 that connects with an input of AEC 340 on the transmission path from TDM network 360 to packet network 370. AEC 340 may be adapted to apply echo cancellation of acoustic echo resulting from an acoustic coupling in packet network 270. As is known, comfort noise or other audible conditioning may be transmitted on the send path of packet network 370.

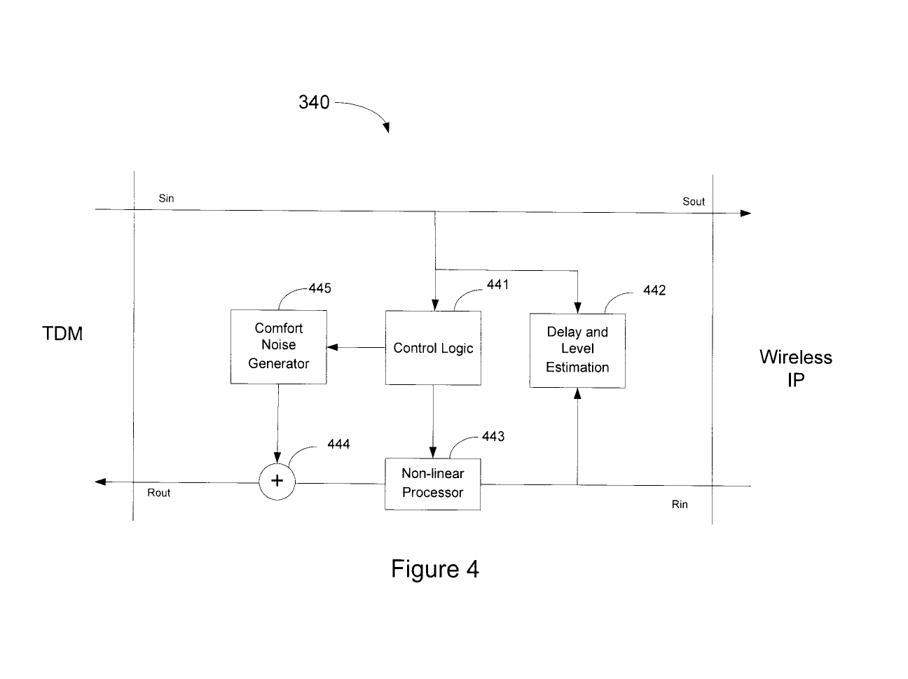

FIG. 4 is a diagrammatic representation of an exemplary embodiment of AEC 340 depicted in FIG. 3. In the exemplary embodiment, AEC 340 comprises control logic 441 and a delay and level estimation function 442 configured to receive a send path signal, Sin, on a transmission path from, for example, a TDM network to an IP network. Delay and level estimation function 442 additionally is configured to receive a receive path signal, Rin, that may include an acoustic echo of the send path signal. Delay and level estimation function 442 comprises logic for estimating the echo path delay required for an acoustic echo of a send path signal to return on the receive path and for estimating the level of the acoustic echo. Output of delay and level estimation function 442 may be conveyed to control logic 441 that controls a non-linear processor 443 and a comfort noise generator 445, the outputs of which are supplied to a summer 444 in the receive path. AEC 340, or a portion thereof, may be implemented as a digital signal processor or other hardware. The effectiveness of AEC 340 is constrained by the accuracy of the acoustic echo path delay estimate of delay and level estimation function 442.

A common deficiency of AEC 340 performance is due to errors in the echo path delay estimation. An echo path delay estimate that diverges from the true echo path delay may result in additional degradation of the receive path signal. Conventional echo path delay estimates comprise an estimate that is coded into or otherwise interfaced with AEC 340 and often exhibits large errors with respect to the true echo path delay. For example, an echo path delay estimate may be parametrically estimated. However, such echo path delay estimates are error prone and are not dynamically calculated based on a particular call configuration or the particular transmission characteristics of the echo path. Problematically, an echo path delay estimate that is smaller than the actual echo path delay may result in signal clipping or distortion, and an echo path delay estimate that is larger than the actual echo path delay may result in passing of acoustic echo on the receive path. Prior art echo path delay estimation mechanisms do not provide for transmission delay characteristic that are measured from the transmission infrastructure or transmission characteristics of the network. In accordance with embodiments disclosed herein, mechanisms for calculating a minimum echo path delay that account for transmission characteristics are provided in a manner that provides for determination of a more accurate echo path delay than that is available in conventional systems.

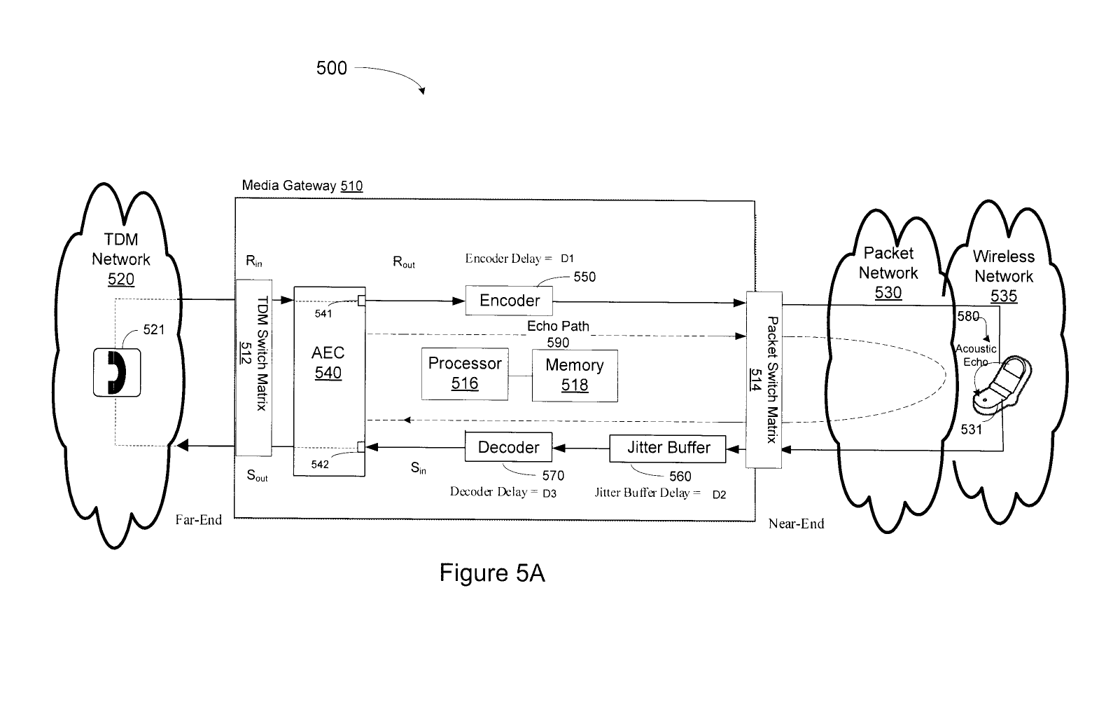

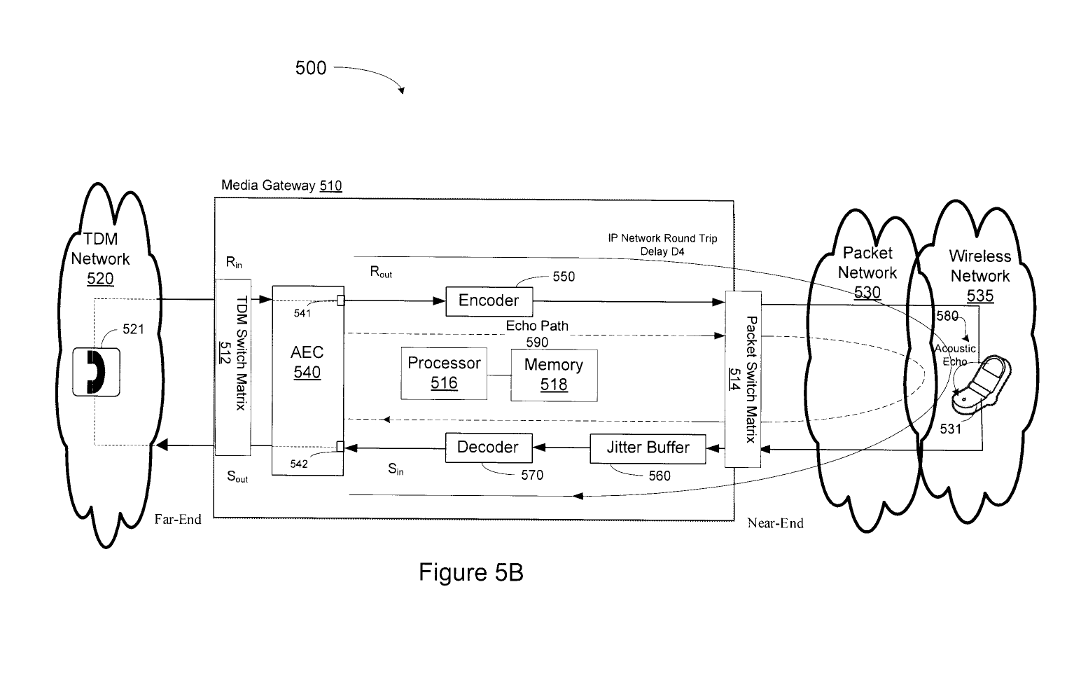

FIG. 5A is a diagrammatic representation of a portion of a network system 500 in which a minimum echo path delay estimate is calculated based on transmission characteristics of the echo path in accordance with embodiments disclosed herein. In particular, a minimum echo path delay is calculated that accounts for processing latencies in the echo path. Network system 500 includes a media gateway 510 that features acoustic echo control implemented in accordance with an embodiment.

Media gateway 510 is an example of a media gateway, such as media gateway 152 depicted in FIG. 1, that may terminate a call in a packet network 530 or wireless network 535. In the present example, media gateway 510 terminates a call between a communication terminal 521 deployed in TDM network 520 with a terminal 531 deployed in wireless or cellular network 535. Other networks, such as a packet network 530, may be deployed in system 500 and may be included in a transmission path between terminals 521 and 531.

After establishing a media path between terminals 521 and 531, terminal 521 may supply a voice signal to system 500 that is transmitted to media gateway 510 and is received thereby as a receive path input signal, Rin, at a TDM switching matrix 512, and a receive path output signal, Rout, may then be processed for transmission to terminal 531. In the depicted example, the receive path output signal, Rout, is processed by an encoder 550, e.g., that may packetize and encode the receive path output signal, Rout, for transmission on packet network 530 via a packet switching matrix 514. The encoded receive path output signal is then transmitted to terminal 531 via packet network 530 and wireless network 535. TDM interface cards and packet interface cards may be respectively coupled with TDM switching matrix 512 and packet switching matrix 514 for providing respective TDM and packet input/output interfaces to system 500.

Terminal 531 may supply a send path signal that is received by media gateway 510 and that is processed thereby for delivery to terminal 521. In the present example, processing of a near end send path signal received by media gateway 510 includes processing by a jitter buffer 560 that provides a buffering delay of the near end send path signal. The buffered send path signal output from jitter buffer 560 may then be supplied to a decoder 570, e.g., that de-packetizes and decodes the send path signal, Sin. AEC 540 may then transmit the de-packetized send path signal, Sin, to terminal 521.

Media gateway 510 may include a processor 516 that may interface with memory device 518 for fetching executable instructions therefrom. Processor 516 may interface with various functions or modules, such as switch matrices 512 and 514, AEC 540, encoder 550, jitter buffer 560, and decoder 570 for managing the operation of various media gateway subsystems and functions.

As discussed above, an acoustic echo 580 may be introduced into the transmission path due to an acoustic coupling between the loudspeaker and microphone of terminal 531. Accordingly, an echo path may be defined that includes a transmission path, or path delay, of a transmission signal that may be returned, at least in part, to the originator as an echo, and a processing delay, e.g., processing latencies introduced by encoder 550, jitter buffer 560, and decoder 570. In the present example, an echo path 590 is defined that includes the receive transmission path from AEC 540 to terminal 531 and the send transmission path from terminal 531 to AEC 540. An echo path delay of echo path 590 comprises the transmission duration, or path delay, of a signal transmission from AEC 540 to terminal 531 and from terminal 531 back to AEC 540, and the processing delay introduced by processing entities deployed in the transmission path.

In accordance with an embodiment, AEC 540 may calculate an echo path 590 delay estimate based on transmission and processing characteristics of echo path 590. In the example depicted in FIG. 5A, one or more discrete latencies may be determined for calculating a minimum echo path 590 delay. Particularly, a processing latency introduced in echo path 590 may be determined for encoder 550, jitter buffer 560, and decoder 570. Other processing nodes or entities, in addition to or in lieu of those depicted, may be similarly accounted for. In the present example, an encoder delay D1 specifies a processing latency of encoder 550 introduced in echo path 590. The encoder delay may, for example, be specified in milliseconds and may be determined by a manufacturer of encoder 550 or through another performance evaluation of encoder 550.

In the send path, a jitter buffer delay D2 specifies the buffer duration of jitter buffer 560 that results in a processing latency in the send path, and a decoder delay D3 specifies a processing latency of decoder 570. The sum of the encoder delay D1, the jitter buffer delay D2, and the decoder delay D3 comprises a minimum duration for which any acoustic reflection of a receive path signal output at port 541 of AEC 540 may be returned as an echo signal at port 542 of AEC 540. Thus, in accordance with an embodiment, a minimum echo path 590 delay (EPD_Min) is calculated according to the following:

EPD_Min=D1+D2+D3 eq. 1

The minimum echo path delay calculation provides for improved AEC operation.

In accordance with another embodiment, the minimum echo path 590 delay may be calculated based on a round trip delay. For example, a round trip delay measurement may be implemented by real time control protocol (RTCP) functions. RTCP functions may be implemented in software stored in memory 518 or may be coded into AEC 540. In any manner, a round trip delay between media gateway 510 and terminal 531 may be calculated by transmission metrics transmitted in RTCP packets. In this implementation, an IP network round trip delay D4 is calculated as an estimate of the minimum echo path delay from media gateway 510 to terminal 531 and back to media gateway 510 as depicted in FIG. 5B. The particular minimum echo path delay calculation shown in FIG. 5B assumes terminal 531 is engaged in a real time protocol (RTP) session.

In one embodiment, the minimum echo path delay may be calculated using RTCP according to the following:

EPD_Min=D₄=tᵣ−LSR−DLSR, eq. 2

where tᵣ is the receiver report (RR) reception time as indicated in an RTCP receiver report packet, LSR is the last sender report (SR) timestamp, and DLSR is the delay since the last sender report. As is known, a sender report and receiver report respectively comprise RTCP data structures that provide reception quality feedback using RTCP report packets. For a detailed description of the RR and SR, see, for example, RFC 3550, “RTP: A Transport Protocol for Real-Time Applications” by Schulzrinne, et al., the description of which is incorporated herein by reference.

The IP network round trip delay D4 may be periodically calculated, and on upon detection of a voice signal supplied on the receive path, AEC 540 may allow the minimum echo path delay EPD_Min to elapse prior to applying acoustic echo suppression or cancellation on the send path from terminal 531 to 521.

In accordance with another embodiment, an echo path model may be calculated that is based on the call configuration for calculating the minimum echo path delay. In a particular implementation, a pre-defined test signal used for echo path evaluation purposes is encoded with an encoder used in the echo path. The test signal may comprise an audio signal that may be supplied in-band on the echo path. In FIGS. 5A and 5B, assume encoder 550 comprises a G.729 codec. Accordingly, the test signal is encoded using encoder 550 or another G.729 encoder. The encoded signal may then be decoded to simulate decoding of the signal by a terminal device, such as terminal 531, and the decoded signal may then be attenuated, e.g., by −25 dB. Attenuation of the decoded signal provides a simulation or model of an acoustic echo of the test signal. The attenuated signal may then be encoded again to simulate encoding of an acoustic reflection or coupling of the test signal. The encoded signal may then be decoded to simulate decoding by a decoder of the media gateway of an encoded acoustic echo of the test signal. Decoding of the encoded signal simulates decoding by the decoder in the transmission path—decoder 570 in the present example.

In this example, the decoded signal that represents the decoded output of decoder 570 may be analyzed, e.g., by a frequency domain analysis, to obtain a numeric characterization, e.g., a spectrum signature, of the simulated echo signal. The frequency domain analysis may be made on a particular frame size, e.g., 40 ms of the signal. With the frequency domain analysis of the test signal, AEC 540 may initiate an echo path timer and apply an instance of the test signal in the voice path at port 541. AEC 540 may then begin monitoring send path input signals, Sin, supplied at port 542 of AEC 540. Analysis of send path input signals, Sin, may be sequentially made on pre-defined frame sizes. On detection of a send path input signal, Sin, having a spectrum signature that matches the simulated echo signal spectrum signature, the echo path timer value may be read. The value of the echo path timer upon detection of an input signal, Sin, having a spectrum signature that matches the simulated echo signal spectrum signature calculated for the test signal may then be assigned as the value of the minimum echo path delay. Upon detection of a voice signal supplied on the receive path, AEC 540 may allow the minimum echo path delay EPD_Min to elapse prior to applying acoustic echo suppression or cancellation on the send path from terminal 531 to 521.

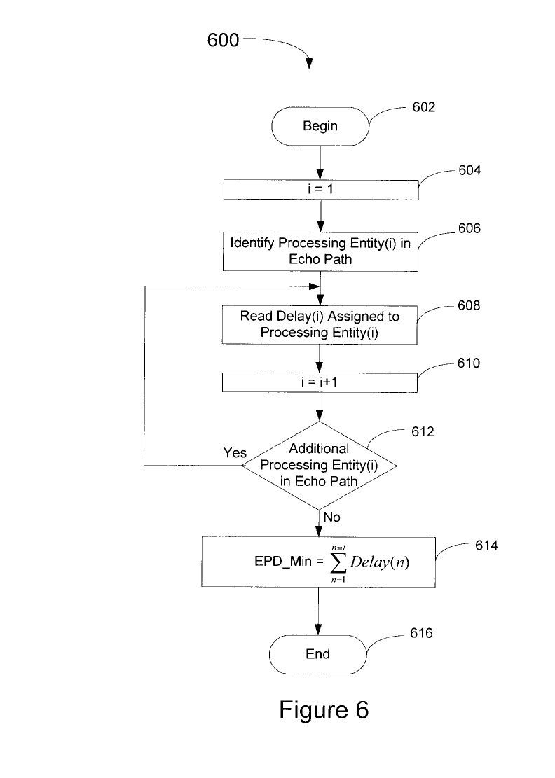

FIG. 6 is a flowchart 600 of an embodiment of a minimum echo path delay calculation subroutine for calculating a minimum echo path delay. In the example minimum echo path delay calculation subroutine depicted in FIG. 6, the minimum echo path delay is calculated as a summation of discrete processing delays introduced in the echo path by various processing entities or functions as described above with reference to FIG. 5A.

The minimum echo path delay calculation subroutine is invoked (step 602), and a variable, i, may be initialized (step 604). A first processing entity(i) in the echo path may then be identified (step 606), and a processing delay, Delay(i), associated therewith may then be read or otherwise obtained by AEC 540 (step 608). For example, for a particular call, an encoder, such as encoder 550 depicted in FIG. 5A, that is used in the call may be identified, and a known processing delay associated therewith may be read or otherwise obtained. In one implementation, a storage device, such as memory 518 deployed on media gateway 510, may maintain a data structure that stores processing delays associated with various processing entities or functions that may be included in the echo path. In an alternative embodiment, processing delays associated with various processing entities may be maintained by AEC 540.

After obtaining the processing delay, Delay(i), associated with the processing entity(i), the variable i may then be incremented (step 610), and the echo path delay calculation subroutine may then proceed to evaluate whether an additional processing entity(i) is included in the echo path (step 612). In the event that another processing entity(i) is included in the echo path, the echo path delay calculation subroutine may return to step 608 to obtain the processing delay, Delay(i), associated with the processing entity(i). When the processing delays have been read for each respective processing entity in the echo path, the minimum echo path delay calculation subroutine may then proceed to calculate the minimum echo path delay, EPD_Min, by summing each processing delay for the processing entities included in the echo path (step 614). The echo path delay calculation subroutine cycle may then end (step 616).

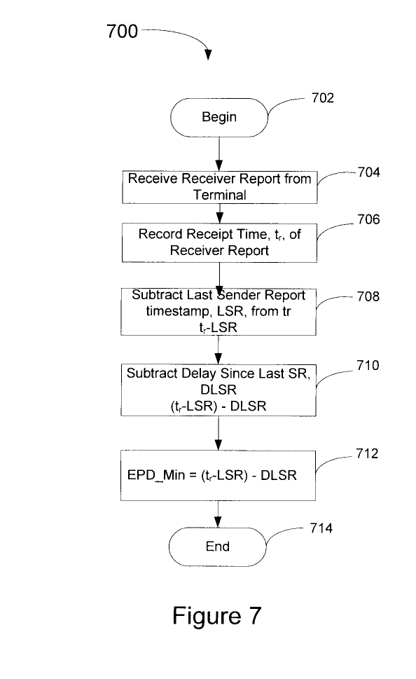

FIG. 7 is a flowchart 700 of another embodiment of a minimum echo path delay calculation subroutine for calculating a minimum echo path delay. In the example minimum echo path delay calculation subroutine depicted in FIG. 7, the echo path delay estimate is calculated as an IP network round-trip delay as described above with reference to FIG. 5B.

The echo path delay calculation subroutine is invoked (step 702), and AEC 540, or another processing entity or service of media gateway 510, receives an RTCP receiver report from terminal 531 (step 704). The time, tᵣ, at which the receiver report is received is recorded (step 706), and the subroutine then subtracts the last sender report timestamp LSR from the receiver report receipt time tᵣ (step 708). The total round-trip time between media gateway 510 and terminal 531 may then be calculated by subtracting the delay since last sender report (DLSR) from the difference between the receiver report receipt time, tᵣ, and the LSR (step 710). The minimum echo path delay may then be set to the round-trip time (step 712). The echo path delay calculation subroutine cycle may then end (step 714).

The minimum echo path delay calculation subroutine of FIG. 7 advantageously does not require identification of each processing entity in the echo path and retrieval of processing latencies associated therewith. Moreover, the subroutine of FIG. 7 provides for dynamic measurement of the minimum echo path delay. Thus, changes in the echo path, e.g., resulting from various configuration changes in the transmission path due to terminal movement or roaming, may be accounted for by simply recalculating the minimum echo path delay.

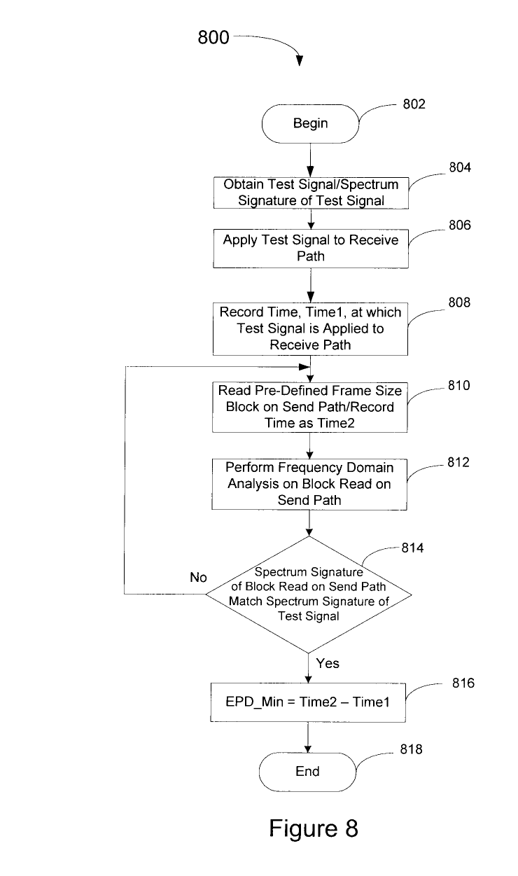

FIG. 8 is a flowchart depicting another embodiment of a minimum echo path delay calculation subroutine for calculating a minimum echo path delay. In the example minimum echo path delay calculation subroutine depicted in FIG. 8, the echo path delay estimate is calculated by modeling an echo signal and performing frequency analyses on the send path.

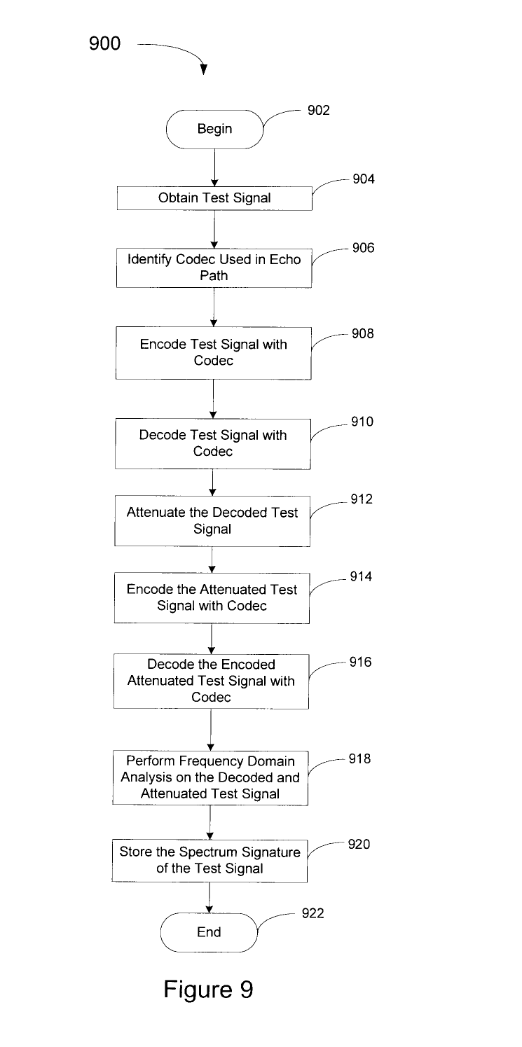

The minimum echo path delay calculation subroutine is invoked (step 802), and a spectrum signature of a test signal is obtained (step 804). The spectrum signature may be obtained from AEC 540, memory 518, another storage device or may be calculated by AEC 540 as described more fully hereinbelow with reference to FIG. 9. The minimum echo path delay calculation subroutine may then apply a test signal to the echo path, e.g., at port 541 of the receive path (step 806), and a time, Time1, at which the test signal is applied to the receive path may be recorded (step 808). The minimum echo path delay calculation subroutine may then begin monitoring the send path by reading a block of a pre-defined frame size on the send path, e.g., at port 542, and recording the time, Time2, at which the block is read (step 810). A frequency domain analysis may then be calculated on the block read on the send path to obtain a spectrum signature thereof (step 812). The spectrum signature calculated on the block read on the send path at step 812 may then be compared with the spectrum signature of the test signal obtained in step 804 to determine if a match exists between the two spectrum signatures (step 814). If no match is identified, processing may return to step 810 to read another block on the send path.

When a signature match is identified at step 814 thus indicating an acoustic echo of the test signal has been received at media gateway 510, the minimum echo path delay EPD_Min may be set to the difference between the time, Time2, at which the block having the spectrum signature matching the test signal spectrum signature was received and the time, Time1, at which the test signal was supplied to the echo path (step 816). The echo path delay calculation subroutine cycle may then end (step 818).

FIG. 9 is a flowchart 900 of an embodiment of a test signal spectrum signature calculation subroutine. The spectrum signature calculation subroutine depicted in FIG. 9 may be used to calculate a spectrum signature of a test signal that may be applied in-band to the echo path for calculating a minimum echo path delay as described above with reference to FIG. 8.

The test signal spectrum signature calculation subroutine is invoked (step 902), and a test signal is obtained by the spectrum signature calculation subroutine (step 904). The test signal may be maintained by AEC 540, by memory 518, or another suitable storage device with which AEC 540 is interfaced. The codec used in the echo path is identified (step 906), and the test signal is encoded therewith (step 908). The test signal is then decoded with the codec (step 910), and the decoded test signal may then be attenuated (step 912), e.g., by 25 dB, to simulate an acoustic reflection of the test signal that may be coupled between the loudspeaker and microphone of a terminal deployed in system 500. The attenuated test signal may again be encoded with the codec (step 914) to simulate encoding of the acoustic echo that may occur at a terminal, such as terminal 531, in the echo path. The encoded and attenuated test signal may then be decoded to simulate decoding of the echo by the media gateway (step 916). A frequency domain analysis may then be performed on the decoded signal obtained at step 916 to obtain a spectrum signature of a simulated echo of the test signal (step 918). The spectrum signature of the test signal may then be stored, e.g., in AEC 540, memory 518, or another suitable storage device (step 920). The test signal spectrum signature may be stored in association with an identifier of the codec used for coding and decoding at steps 908, 910, 914, and 916. The spectrum signature calculation subroutine cycle may then end (step 922).

The processing steps of FIG. 9 may be repeated for each codec available on media gateway 510. In this manner, spectrum signatures of a simulated echo of the test signal may be obtained for each codec available to media gateway 510, and the echo path delay calculation subroutine described with reference to FIG. 8 may obtain the appropriate spectrum signature of the simulated echo of the test signal at step 804 upon identification of the codec used in the echo path for which the minimum echo path delay is to be calculated.

The minimum echo path delay calculation subroutine described with reference to FIGS. 8 and 9 advantageously provides for dynamic calculation of a minimum echo path delay. The minimum echo path delay calculation may be periodically repeated during a call to account for changes in the echo path.

Various utilizations of the minimum echo path delay calculations and double talk detection mechanisms described herein may be used by an AEC. For example, acoustic echo suppression may be delayed by an AEC until expiration of the echo path timer in response to detection of a receive path voice signal. Additionally, an interval that defines an estimated range of the echo path delay may be determined that includes the calculated minimum echo path delay. In accordance with an embodiment, the estimated range of echo path delay may be specified according to the following:

EROEPD=(EPD_Min,EPD_Max) eq. 3

where EPD_Min is calculated by any of the techniques described above that account for network transmission characteristics. The maximum echo path delay (EPD_Max) value may be assigned a value that specifies an interval of the echo path delay that may be allowed to expire in addition to the minimum echo path delay prior to acoustic echo suppression being applied in a send path after detection of a voice signal in the receive path. For instance, the EPD_Max value may be pre-defined and dependent on the particular mechanism used for calculating the minimum echo path delay, particular network configuration, or based on other network metrics or latency estimates. Those skilled in the art will recognize numerous other applications for improving echo control in a network system by exploiting the minimum echo path delay calculation techniques described herein.

As described, various mechanisms are provided for calculating a minimum echo path delay. The mechanisms described herein provide for an accurate calculation of a minimum echo path delay based on transmission characteristics of the echo path. Moreover, the minimum echo path delay calculations may be periodically repeated thus providing for dynamic calculation of the minimum echo path delay in a manner that accounts for variations in echo path characteristics. Minimum echo path delay calculations described herein may be utilized by network-based echo controllers for provide enhanced echo suppression or calculation. Voice signal distortion and echo pass through commonly encountered due to errors in double-talk detection resulting from erroneous echo path delay estimates may be significantly reduced or eliminated by exploiting the accurate calculation of the minimum echo path delay, and thus call quality may be significantly enhanced.

The network and device examples depicted in FIGS. 1-5 are intended as examples, and not as an architectural limitations, of network systems and components in which embodiments disclosed herein may be implemented. Embodiments disclosed herein may be implemented in any network system comprising heterogeneous network entities.

The flowcharts of FIGS. 6-9 depict process serialization to facilitate an understanding of disclosed embodiments and are not necessarily indicative of the serialization of the operations being performed. In various embodiments, the processing steps described in FIGS. 6-9 may be performed in varying order, and one or more depicted steps may be performed in parallel with other steps. Additionally, execution of some processing steps of FIGS. 6-9 may be excluded without departing from embodiments disclosed herein. Moreover, those skilled in the art will recognize that embodiments described herein may be implemented in routines that feature interrupt control, and processing flow may be accordingly impacted. The illustrative block diagrams and flowcharts depict process steps or blocks that may represent modules, segments, or portions of code that include one or more executable instructions for implementing specific logical functions or steps in the process. Although the particular examples illustrate specific process steps or procedures, many alternative implementations are possible and may be made by simple design choice. Some process steps may be executed in different order from the specific description herein based on, for example, considerations of function, purpose, conformance to standard, legacy structure, user interface design, and the like.

Aspects of the present invention may be implemented in software, hardware, firmware, or a combination thereof. The various elements of the system, either individually or in combination, may be implemented as a computer program product tangibly embodied in a machine-readable storage device for execution by a processing unit. Various steps of embodiments of the invention may be performed by a computer processor executing a program tangibly embodied on a computer-readable medium to perform functions by operating on input and generating output. The computer-readable medium may be, for example, a memory, a transportable medium such as a compact disk, a floppy disk, or a diskette, such that a computer program embodying the aspects of the present invention can be loaded onto a computer. The computer program is not limited to any particular embodiment, and may, for example, be implemented in an operating system, application program, foreground or background process, driver, network stack, or any combination thereof, executing on a single computer processor or multiple computer processors or another instruction execution apparatus. Additionally, various steps of embodiments of the invention may provide one or more data structures generated, produced, received, or otherwise implemented on a computer-readable medium, such as a memory.

Although embodiments of the present disclosure have been described in detail, those skilled in the art should understand that they may make various changes, substitutions and alterations herein without departing from the spirit and scope of the present disclosure. Accordingly, all such changes, substitutions and alterations are intended to be included within the scope of the present disclosure as defined in the following claims.

What is claimed is:

1. A method of determining an echo path delay in a communication network, comprising:
receiving a signal on a send path transmitted to a communication terminal;
determining characteristics of an echo path between a media gateway and the communication terminal; and
calculating a minimum echo path delay between the media gateway and the communication terminal based on the characteristics, wherein the characteristics include a processing latency associated with one or more processing entities in the echo path and a path delay of the echo path.

2. The method of claim 1, further comprising completing a media path setup with the communication terminal including configuration of a receive path from the media gateway to the communication terminal, and a send path from the communication terminal to the media gateway.

3. The method of claim 1, wherein determining characteristics further comprises identifying the one or more processing entities in the echo path each having a respective processing delay associated therewith, and wherein calculating a minimum echo path delay further comprises calculating a sum of each respective processing delay, wherein the minimum echo path delay is set to the sum.

4. The method of claim 3, wherein the one or more processing entities includes at least one of an encoder, jitter buffer, and a decoder, and wherein the respective processing delay comprises an encoder processing delay, a jitter buffer delay, and a decoder processing delay.

5. The method of claim 3, wherein determining characteristics further comprises identifying a round-trip transmission delay between the communication terminal and the media gateway.

6. The method of claim 5, wherein identifying a round-trip transmission delay further comprising measuring the round-trip transmission delay using a real-time control protocol function.

7. The method of claim 1, wherein determining characteristics further comprises determining a packet network round trip delay between the media gateway and the communication terminal, and wherein calculating a minimum echo path delay further comprises setting the minimum echo path delay to the round trip delay.

8. The method of claim 7, wherein determining a packet network round trip delay further comprises:
recording a receipt time of a real time control protocol receiver report at the media gateway;
calculating a first difference between a real time control protocol last sender report timestamp and the receipt time; and
calculating a second difference between the first difference and a real time control protocol delay since last sender report, wherein the minimum echo path delay is set to the second difference.

9. The method of claim 1, wherein determining characteristics of the echo path further comprises performing a spectrum analysis of the echo path.

10. The method of claim 9, wherein performing a spectrum analysis further comprises:
modeling transmission of an audio signal through the echo path;
obtaining a spectrum signature of the audio signal;
evaluating a signal on a send path from the communication terminal to the media gateway; and
calculating a spectrum signature of the signal.

11. The method of claim 10, wherein evaluating a signal on the send path comprises applying an instance of the audio signal in-band on the echo path, the method further comprising recording a time at which the audio signal is applied to the echo path.

12. The method of claim 11, further comprising:
comparing the spectrum signature of the signal with the spectrum signature of the audio signal;
determining whether the spectrum signature of the signal matches the spectrum signature of the audio signal; and
responsive to determining the spectrum signature of the signal matches the spectrum signature of the audio signal, setting the minimum echo path delay to a difference between a time at which the signal is evaluated on the send path and the time at which the test signal is applied to the echo path.

13. The method of claim 10, wherein modeling transmission of an audio signal comprises:
encoding the audio signal with an instance of an encoder including in the echo path;
decoding the encoded audio signal;
attenuating the decoded audio signal to produce an attenuated audio signal;
encoding the attenuated audio signal; and
decoding the encoded and attenuated audio signal.

14. A computer-readable medium having computer-executable instructions for execution by a processing system, the computer-executable instructions for calculating an echo path delay, comprising:
instructions that receive a signal on a send path transmitted to a communication terminal;
instructions that determine characteristics of an echo path between a media gateway and the communication terminal; and
instructions that calculate a minimum echo path delay between the media gateway and the communication terminal based on the characteristics, wherein the characteristics include a processing latency associated with one or more processing entities in the echo path and a path delay of the echo path.

15. The computer-readable medium of claim 14, further comprising instructions that complete a media path setup with the communication terminal including completing configuration of a receive path from the media gateway to the communication terminal and a send path from the communication terminal to the media gateway.

16. The computer-readable medium of claim 14, wherein the instructions that determine characteristics further comprises instructions that identify the one or more processing entities in the echo path each having a respective processing delay associated therewith, and wherein the instructions that calculate a minimum echo path delay further calculate a sum of each respective processing delay, wherein the minimum echo path delay is set to the sum.

17. The computer-readable medium of claim 16, wherein the one or more processing entities include at least one of an encoder, jitter buffer, and a decoder, and wherein the respective processing delay comprises an encoder processing delay, a jitter buffer delay, and a decoder processing delay.

18. The computer-readable medium of claim 16, wherein the instructions that determine characteristics identify a round-trip transmission delay between the communication terminal and the media gateway.

19. The computer-readable medium of claim 18, wherein the instructions that identify a round-trip transmission delay measure the round-trip transmission delay using a real-time transmission control protocol function.

20. The computer-readable medium of claim 14, wherein the instructions that determine characteristics further comprises instructions that determine a packet network round trip delay between the media gateway and the communication terminal, and wherein the instructions that calculate a minimum echo path delay further set the minimum echo path delay to the round trip delay.

21. The computer-readable medium of claim 20, wherein the instructions that identify a packet network round trip delay further comprise:
instructions that record a receipt time of a real time control protocol receiver report at the media gateway;
instructions that calculate a first difference between a real time control protocol last sender report timestamp from the receipt time;
instructions that calculate a second difference between the first difference and a real time control protocol delay since last sender report, wherein the minimum echo path delay is set to the second difference.

22. The computer-readable medium of claim 14, wherein the instructions that determine characteristics of the echo path further comprise instructions that perform a spectrum analysis of the echo path.

23. The computer-readable medium of claim 22, wherein the instructions that perform a spectrum analysis further comprise:
instructions that model transmission of an audio signal through the echo path;
instructions that obtain a spectrum signature of the audio signal;
instructions that evaluate a signal on a send path from the terminal to the media gateway; and
instructions that calculate a spectrum signature of the signal.

24. The computer-readable medium of claim 23, wherein the instructions that evaluate a signal on the send path comprise instructions that apply an instance of the audio signal in-band on the echo path, the computer-readable medium further comprising instructions that record a time at which the audio signal is applied to the echo path.

25. The computer-readable medium of claim 24, further comprising:
instructions that compare the spectrum signature of the signal with the spectrum signature of the audio signal;
instructions that determine whether the spectrum signature of the signal matches the spectrum signature of the audio signal; and
instructions that, responsive to determining the spectrum signature of the signal matches the spectrum signature of the audio signal, set the minimum echo path delay to a difference between a time at which the signal is evaluated on the send path and the time at which the test signal is applied to the echo path.

26. The computer-readable medium of claim 23, wherein the instructions that model transmission of an audio signal comprise:
instructions that encode the audio signal with an instance of an encoder including in the echo path;
instructions that decode the encoded audio signal;
instructions that attenuate the decoded audio signal to produce an attenuated audio signal;
instructions that encode the attenuated audio signal; and
instructions that decode the encoded and attenuated audio signal.

27. A converged network, comprising:
a wireless network adapted to terminate a media path with a terminal; and
a media gateway adapted to interface with the wireless network on the media path and receive a signal on a send path transmitted to the terminal, the media gateway comprising an acoustic echo controller adapted to determine characteristics of an echo path comprising at least a portion of the media path and calculate a minimum echo path delay between the media gateway and the based on the characteristics, wherein the characteristics include a processing latency associated with one or more processing entities in the echo path and a path delay of the echo path.

28. The system of claim 27, wherein the acoustic echo controller determines characteristics by identifying the one or more processing entities in the echo path each having a respective processing delay associated therewith, and wherein the minimum echo path delay is calculated by summing each respective processing delay.

29. The system of claim 28, wherein the one or more processing entities comprise one or more of an encoder, a jitter buffer, and a decoder disposed on the media gateway, and wherein the respective processing delay comprises an encoder processing delay, a jitter buffer delay, and a decoder processing delay.

30. The system of claim 28, wherein the acoustic echo controller identifies a round-trip transmission delay between the terminal and the media gateway.

31. The system of claim 30, wherein the round-trip transmission delay is measured using a real-time control protocol function.

32. The system of claim 27, further comprising a packet network included in the media path, wherein the characteristics are determined by calculating a packet network round trip delay between the media gateway and the terminal, and wherein the minimum echo path delay is set to the round trip delay.

33. The system of claim 32, wherein the packet network round trip delay is calculated by recording a receipt time of a real time control protocol receiver report at the media gateway, calculating a first difference between a real time control protocol last sender report timestamp and the receipt time, calculating a second difference between the first difference and a real time control protocol delay since last sender report, wherein the minimum echo path delay is set to the second difference.

34. The system of claim 27, wherein the characteristics of the echo path are determined by performing a spectrum analysis of the echo path.

35. The system of claim 34, wherein the spectrum analysis is performed by modeling transmission of an audio signal through the echo path, obtaining a spectrum signature of the audio signal, evaluating a signal on a send path from the terminal to the media gateway, and calculating a spectrum signature of the signal.

36. The system of claim 35, wherein evaluating a signal on the send path comprises applying an instance of the audio signal in-band on the echo path, and wherein the acoustic echo controller records a time at which the audio signal is applied to the echo path.

37. The system of claim 36, wherein the acoustic echo controller compares the spectrum signature of the signal with the spectrum signature of the audio signal, determines whether the spectrum signature of the signal matches the spectrum signature of the audio signal, and responsive to determining the spectrum signature of the signal matches the spectrum signature of the audio signal, sets the minimum echo path delay to a difference between a time at which the signal is evaluated on the send path and the time at which the test signal is applied to the echo path.

38. The system of claim 35, wherein the acoustic echo controller models transmission of an audio signal by encoding the audio signal with an instance of an encoder including in the echo path, decoding the encoded audio signal, attenuating the decoded audio signal to produce an attenuated audio signal, encoding the attenuated audio signal, and decoding the encoded and attenuated audio signal.
